(19) United States
(12) Patent Application Publication
(10) Pub. No.: US 2025/0069021 A1
(43) Pub. Date: Feb. 27, 2025

(54) CONVEYING ITEMS USING A DISTRIBUTED MULTI-AGENT ALLOCAITON METHOD

(71) Applicant: B.G. Negev Technologies and Applications Ltd., Beer Sheva (IL)

(72) Inventors: Roie ZIVAN, Meitar (IL); Sofia AMADOR Nelke, Kiryat Ono (IL)

(73) Assignee: B.G. Negev Technologies and Applications Ltd., Beer Sheva (IL)

(21) Appl. No.: 18/723,842

(22) PCT Filed: Dec. 21, 2022
(86) PCT No.: PCT/IB2022/062565

§ 371 Date: Jun. 24, 2024

Related U.S. Application Data
(60) Provisional application No. 63/293,101, filed on Dec. 23, 2021.

(51) Int. Cl. G06Q 10/083

(52) U.S. Cl. CPC G06Q 10/083

(57) ABSTRACT

A computer based method for executing a task of conveying a group of items (GOI) to a set of targets, the method may include (a) receiving, by a computerized system, (i) a request to execute the task, (ii) GOI-related task skills required for conveying the group of items, and (iii) one or more parameters of a task utility function; (b) associating, by a task agent hosted by the computerized system, resource-skill agents (RSAs) to each GOI-related task skill; wherein the RSAs are heterogenous; (c) informing the RSAs about the GOI-related task skills; (d) participating, by the task agent, in multiple bidding iterations until reaching a convergence condition; wherein the bidding iterations explore only a fraction of all possible task allocations; and (c) conveying, by the computerized system, at least one item towards at least one target of the set of target when the computerized system is allocated, during the multiple bidding iterations, to convey the at least one item towards the at least one target.

### CROSS REFERENCE

This application claims priority from U.S. provisional patent 63/293,101 filing date December 23, 202, which is incorporated herein in its entirety.

### BACKGROUND

Logistics has become a major aspect in the everyday lives of businesses and individuals (customers). While computation and communication allow people from around the world to interact in the speed of light, the transportation of goods from businesses to other businesses, and from businesses to customers is still performed mostly by low tech ships and vehicles. Moreover, logistic companies must maintain warehouses in which they store the goods before they are distributed.

The resources, or “computerized systems” providing the delivery capability in these logistic problems are heterogeneous, as they may be vehicles of one or more types, robots or drones. These heterogeneous vehicles are assigned to transfer items from their point of departure to their destination.

The items to be delivered can also be heterogeneous. An item is classified by the capability required to transfer it and by the utility the system derives from the transfer.

There is a growing need to provide an effective method for conveying items, that may be based on an effective method for allocating the delivery of items between heterogenous computerized systems.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates an example of a method;

FIG. 2 illustrates an example of a method;

FIG. 3 illustrates an example of a method;

FIG. 4 illustrates an example of a method;

FIG. 5 illustrates an example of a method;

FIG. 6 illustrates an example of a method;

FIG. 7 illustrates an example of computerized systems, items of a GOP and a set of targets;

FIG. 8 illustrates an example of computerized systems, items of a GOP located at a set of sources;

FIG. 9 illustrates an example of computerized systems hosted by robots that convey items from a warehouse, and a set of sources; and

FIG. 10 illustrates an example of tasks agents and associated areas.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that can be executed by the system and should be applied mutatis mutandis to a non-transitory computer readable medium that stores instructions that once executed by a computer result in the execution of the method.

Any reference to the term “conveying” may be applied mutatis mutandis to “distributing” and/or “collecting” and/or “delivering”.

A computerized system is a system that includes computational resources and memory resources and is configured to execute instructions. The computational resources may include one or more processing circuits. A processing circuit may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits. The memory resources may include one or more memory units and/or one or more memory banks and/or registers and the like. The computerized system may include one or more integrated circuits and/or one or more systems on chip and/or one or more printed circuits boards, and the like. The computerized system may executed instructions such as instructions that cause the computerized system to host an agent-being a task agent or a resource-skill agent. The computerized system may be a vehicle or may be included in a vehicle. A vehicle is an entity that may convey an item. The vehicle can be a ground vehicle, an airborne vehicle, a water vehicle, a robot, an autonomous vehicle, a vehicle with driver assistance functions, and the like.

Any reference to conveying a group of items to a set of targets may be applied, mutatis mutandis to conveying a group of items from a set of sources.

Any reference to a computerized system should applied mutatis mutandis to a vehicle or any other self-propelled or movable computerized system. For example—in cases that the computerized system is described as conveying an item—then that computerized system is deemed to include a propulsion unit and/or motor, and means for carrying one or more items.

There may be provided a computer based method for executing a task of conveying a group of items (GOI) to a set of targets. The computer based method is a distributed method that involves performing multiple bidding iterations between multiple computerized systems, until converging. When converged—an allocation of items of the GOI between at least some of the multiple computerized system is obtained. During the multiple bidding iterations one of the computerized systems acts as a task agent and other computerized systems may act as resource-skill agents (RSAs). The task agent may be required to perform more computations that a RSA, but in any case the computations are relatively simple and do not require extensive computational resources—which may enable even a computerized system with relatively limited computational and memory resources to act as a task agent. RSAs may allocate even fewer computational and memory resources to the multiple bidding iterations—and may be even easier to implement. The multiple bidding iterations also involve an exchange of messages (such as bidding messages or task agent messages with requested contributions of the RSAs)—and these messages may be very compact (for example—have a size that does not exceed 150, 200, 250 bytes)—which also dramatically reduces the memory resources used for storing such messages, reduces communication resources required to convey such messages, can reduces the cost associated with re-transmission of missed messages, and allows the perform the bidding iteration under severe bandwidth constraints. The task agent message informing the GOI-related task skills is also compact.

The simplicity of the multiple bidding iterations enables to execute the bidding process in real time—for example execute each bidding iteration in less than a second, less than 5 seconds, less than 10 seconds, less than a minute, and the like.

The bidding process does not evaluate all possible allocations of computerized systems to conveying any of the items—and may utilize a local optimization process—which dramatically shortens the bidding process and provides significant savings in computational and memory resources.

The suggested method may include by allocating a task agent to an area that includes the set of targets—whereas the bidding process may be responsive to the GOI as a whole as well to the individual items. The allocation of the task agent may be based on one or more parameters of the task agent—for example available computational resources and/or available memory resources (even though the required amount of resources is limited), location of the computerized agent in relation to the area, whether the task agent already conveyed items in the area, and the like. The allocation of task agents to areas may be determined in a distributed manner (in which at least some of the computerized agents participate), in a centralized manner, by an entity that differs from the computerized systems that may act as an agent (task agent or RSA), and the like.

The definition of areas may be determined dynamically—based on the locations of targets that should receive the items—whereas the locations may change over time. The areas may be defined in any manner—for example by clustering and/or groping targets to provide sets of targets and/or by clustering and/or grouping items to provide different GOIs.

There may be multiple task agents that are allocated do different areas and are responsive to different GOIs. A single RSA may participate, at the same period of time, in multiple bidding iterations with more than a single task agent. A decision of the RSA to participate in a distribution of an item located at a given area (associated with a giver task agent) may impact the allocation of RSA of another task agent that was rejected by the RSA.

The method may utilize at least some parts of the Fisher market clearing task allocation algorithm—but may use other algorithms.

The suggested solution, especially when utilizing the at least some parts of the Fisher market clearing task allocation algorithm—is scalable in the sense that the required computational and/or memory resources of the claimed method may be polynomial or pseudo-polynomial (quadratic in a distributed solver) in the number of agents and tasks (the larger amount the two). In practice, a few seconds are required for deciding on the allocation of hundreds of agents and tasks.

Even when using at least some parts of the Fisher market clearing process—the method differs from the Fisher market clearing process in various aspects—for example—by allocating a task agent per area and performing the bidding iterations based on one or more GOI parameters—as well as single items parameters.

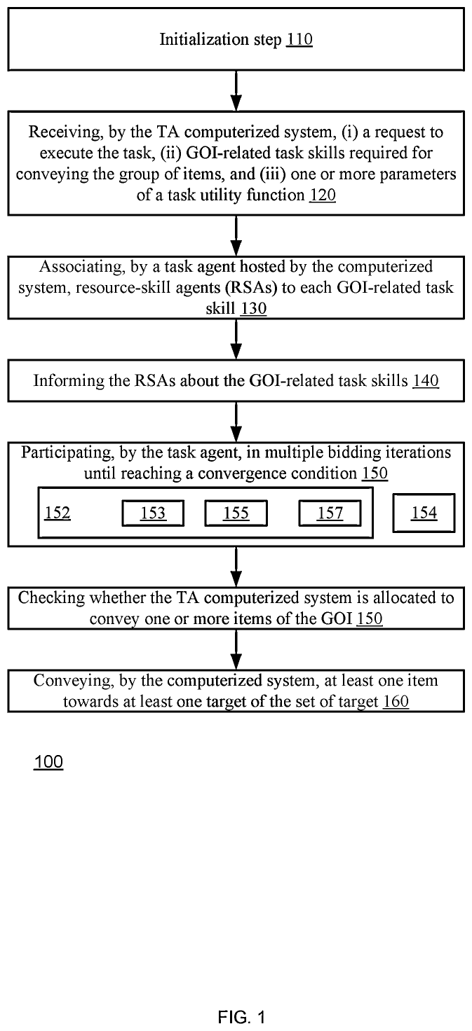

FIG. 1 illustrates an example of a computer based method 100 for executing a task of conveying a group of items (GOI) to a set of targets.

Method 100 may start by an initialization step 110. The initialization step may include allocating a computerized system to execute method 100. This computerized system may be referred to as a task agent (TA) computerized system.

Step 110 may be followed by step 120 of receiving, by the TA computerized system, (i) a request to execute the task, (ii) GOI-related task skills required for conveying the group of items, and (iii) one or more parameters of a task utility function.

It is assumed, for simplicity of explanation, that the items may be initially located at a same location (for example at an output of a warehouse).

Step 120 may include receiving information such as the items that need to be transferred, their destinations, their current locations (if not located at the same location), the utility derived from transferring them (taking into consideration the importance of the item), an urgency of their delivery, a cost for late delivery, the capabilities required from vehicles that transfer them, such as the capability to handle a certain weight, the transferring vehicles (“last mile vehicles”), their current locations with respect to the pick-up locations, capabilities, the cost for having them not complete their current assignments, and their current locations.

Step 120 may be followed by step 130 of associating, by a task agent hosted by the computerized system, resource-skill agents (RSAs) to each GOI-related task skill. The RSAs are heterogenous.

The TA computerized system may belong or may be a vehicle of a first type while the RSAs may belong or may be computerized systems of one or more other types. Alternatively—the TH computerized system may belong or may be of the same type as one of the RSAs.

The TA computerized system may have more computational and/or memory resources than at least some of the RSAs—or have the same amount of resources that at least one of the RSAs—or even lesser amount of resources that one or more of the RSAs.

Step 130 may be followed by step 140 of informing the RSAs about the GOI-related task skills.

The GOI-related task skills may reflect the overall skills required to convey the entire tasks. For example the GOI-related task skill may include at least one:
a. A capability to convey a items having a total weight that is an aggregate weight of all items of the GOI.
b. A capability to convey a items having a total volume that is an aggregate volume of all items of the GOI.
c. A capability to convey a items of all types of the items of the GOI.
d. A capability to convey item at an urgency that represents timing constraints of all items of the GOI. Any GOI urgency determining function may be applied on the timing constraints associated with the different items of the GOI. For example—a maximal urgency level, yet for another example—a combination of the timing constraints and a number of items related to each value of the timing constraints.
e. A capability to convey item at an priority that represents timing constraints of all items of the GOI. Any GOI priority determining function may be applied on the timing constraints associated with the different items of the GOI. For example—a maximal priority level, yet for another example—a combination of the timing constraints and a number of items related to each value of the timing constraints.

Step 140 may be followed by step 150 of participating, by the task agent, in multiple bidding iterations until reaching a convergence condition. The bidding iterations explore only a fraction of all possible task allocations. The bidding iterations may take into account (using the task utility function) the cost of conveying an item by each RSA—for example the fuel consumption, and the like.

Step 150 may include multiple iterations of step 152 of participating in a bidding iteration of the multiple bidding iteration.

Step 152 may include:
a. Step 153 of receiving bidding messages from the RSAs, wherein the bidding messages provide information about (i) suggested contributions of the RSAs to an execution of the task, and (ii) interruption penalties for the RSAs to stop other tasks currently executed by the RSAs.
b. Step 155 of determining, by the task agent, based on the bidding messages and the one or more parameters of the task utility function, requested contributions of the RSAs to the execution of the task; wherein at least some of the suggested contributions are calculated by the RSAs in response to previously requested contributions of the RSAs to the execution of the task. The determining may apply a local optimization process. Local in the sense that it is not exhaustive and does not cover all possible allocations.
c. Step 157 of sending, by the computerized system and to the RSAs, the requested contributions of the RSAs to the execution of the task. The requested contribution can be sent is a response message. The size of the task agent message may equal the size of the bidding message, may be smaller than the bidding message or may be larger. Even when larger than the bidding message the response message may be compact—for example—may not exceed 300, 400 byte and the like.

The task agent message (of step 157) may include an RSA benefit (for example payment) to be made to the task agent if it accepts the bidding. An RSA that negotiates with multiple task agents may prioritize working with the task agent that offers the highest benefit—or may perform a selection of the task agent in view of other considerations. The task agent may determine the RSA benefit in any manner—for example as a certain percentage of the benefit the task agent obtains from the fulfillment of the task, by applying the task utility function—or any other function.

During the second till final bidding iteration (of the multiple bidding iterations) the bidding messages from the RSAs may be responsive to the requested contributions of the RSAs from a previous bidding iteration.

An RSA may participate in bidding iterations with a plurality of tasks agents allocated to a plurality of areas—and may select during any bidding iteration to cooperate with one of the plurality of task agents—and may even change its decision during the bidding iterations. Accordingly—the identity and/or number of RSAs that participate in one bidding iteration may differ from the identity and/or number of RSAs that participate in another bidding iteration.

The outcome of the multiple bidding iterations is an allocation of tasks to selected computerized systems that host agents. The selected computerized systems may host RSAs. One of the selected computerized systems may host the task agent.

Step 150 may be followed by checking whether the TA computerized system is allocated to convey one or more items of the GOI.

When the answer is positive—step 150 may be followed by step 160 of conveying, by the computerized system, at least one item towards at least one target of the set of target.

When the answer is negative—the computerized system does not convey any of the items of the GOI.

The task utility function may provide an indication about the monetary benefit gained to a conveying entity as a result of the conveying of the items of the GOI. Accordingly—the one or more parameters of the task utility function may include a profit gained from fulfilling the task and/or an item delivery urgency parameter. It should be noted that the task utility function may consider other benefits—for example reduction in emissions.

The GOI-related task skills may relate to the GOI—and may include, for example, item-type conveying capability and/or item-weight conveying capability, and/or item-volume conveying capability.

The item-type may be, for example, selected out of a fragile item, a non-fragile item, an item that requires certain environmental condition during a conveying of the item, or an item that may be conveyed regardless of environmental conditions. Different types of items may require different conveying conditions.

A bidding message from a given RSA may be compact. For example—it may consists essentially of (i) an expected time of arrival of the RSA to a task distribution location, (ii) one or more RSA item conveying skills, (iii) a status of the RSA and (iv) at least one interruption penalty for the RSAs to stop another task currently executed by the RSA. The status may be limited to parameters that are relevant to the conveying of an item—other than the RSA item conveying skills—for example—the status of the battery or the amount of fuel in the tank.

The at least one interruption penalty comprises multiple interruption penalties for stopping the other task at different stages of completion of the other task. The at least one interruption penalties may be determined by the task agent that assigned the RSA the other task.

When the method utilizes at least a part of the distributed solving of a Fisher market clearing process—then that part may include the executing of steps 130, 140 and 150.

In one example of the implementation of method 100 the GOI are conveyed by a computerized system to an area distribution location and then are distributed, from the area distribution location, to the set of targets.

The TA computerized system may be configured to convey the GOI to the area distribution location and/or may be configured to convey one or more items of the GOI to one or more targets of the set of targets. Whether the TA computerized system performs any of the above—depends on the outcome of the bidding iterations.

The computerized system may belong to or may be vehicle of various types—trucks, trains, planes, drones, motorcycles, robots, manned vehicles, unmanned vehicles, and the like.

For example—the GOI may include a group of packages that should be delivered from a warehouse to customers in a city. Method 100 may be used to determine that manner in which the packages are provided to the customers. The vehicles may include or may be the computerized systems that participate in the execution of method 100. One or more of the computerized systems that participates in the execution of method 100 may not belong to a vehicle or may not be a vehicle.

The packages are loaded to trucks, according to the neighborhoods in the city where they are designated to be delivered, i.e., two packages intended for the same neighborhood may be loaded to the same truck. The trucks travel to a location in the neighborhood (to the center if possible), to which the packages they carry are designated to be delivered. The packages are unloaded from the trucks and delivery unmanned airborne vehicles and/or other ground vehicles such as scooters that carry them the “last mile” to their customers' addresses. Simultaneously, packages that need to be returned may be brought to the trucks. When this delivery is completed, the trucks return to the warehouse to unload the returned packages and reload packages to be delivered. The vehicles, such as drones and scooters may be reassigned for delivering packages from other trucks. The unloading may be executed by warehouse computerized systems that may apply a method (such as method 100), for allocating the warehouse computerized systems to the unloading.

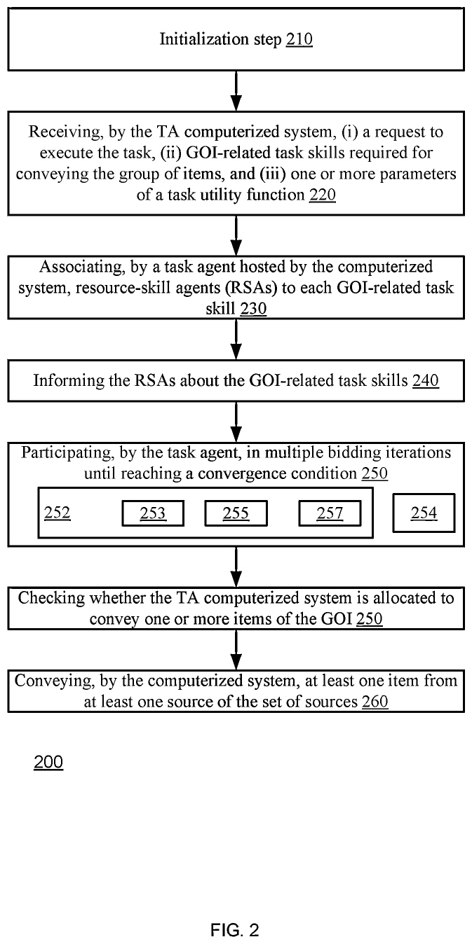

FIG. 2 illustrates an example of method 200 for executing a task of conveying a group of items (GOI) from a set of sources.

Method 200 may start by an initialization step 210. The initialization step may include allocating a computerized system to execute method 200. This computerized system may be referred to as a task agent (TA) computerized system.

Step 210 may be followed by step 220 of receiving, by the TA computerized system, (i) a request to execute the task, (ii) GOI-related task skills required for conveying the group of items, and (iii) one or more parameters of a task utility function.

Step 220 may be followed by step 230 of associating, by a task agent hosted by the computerized system, resource-skill agents (RSAs) to each GOI-related task skill. The RSAs are heterogenous.

The TA computerized system may belong or may be a vehicle of a first type while the RSAs may belong or may be computerized systems of one or more other types. Alternatively—the TH computerized system may belong or may be of the same type as one of the RSAs.

The TA computerized system may have more computational and/or memory resources than at least some of the RSAs—or have the same amount of resources that at least one of the RSAs—or even lesser amount of resources that one or more of the RSAs.

Step 230 may be followed by step 240 of informing the RSAs about the GOI-related task skills.

The GOI-related task skills may reflect the overall skills required to convey the entire tasks. For example the GOI-related task skill may include at least one:
a. A capability to convey a items having a total weight that is an aggregate weight of all items of the GOI.
b. A capability to convey a items having a total volume that is an aggregate volume of all items of the GOI.
c. A capability to convey a items of all types of the items of the GOI.
d. A capability to convey item at an urgency that represents timing constraints of all items of the GOI. Any GOI urgency determining function may be applied on the timing constraints associated with the different items of the GOI. For example—a maximal urgency level, yet for another example—a combination of the timing constraints and a number of items related to each value of the timing constraints.
e. A capability to convey item at an priority that represents timing constraints of all items of the GOI. Any GOI priority determining function may be applied on the timing constraints associated with the different items of the GOI. For example—a maximal priority level, yet for another example—a combination of the timing constraints and a number of items related to each value of the timing constraints.

Step 240 may be followed by step 250 of participating, by the task agent, in multiple bidding iterations until reaching a convergence condition. The bidding iterations explore only a fraction of all possible task allocations. The bidding iterations may take into account the cost of conveying an item by each RSA—for example the fuel consumption, and the like.

Step 250 may include multiple iterations of step 252 of participating in a bidding iteration of the multiple bidding iteration.

Step 252 may include:
a. Step 253 of receiving bidding messages from the RSAs, wherein the bidding messages provide information about (i) suggested contributions of the RSAs to an execution of the task, and (ii) interruption penalties for the RSAs to stop other tasks currently executed by the RSAs.
b. Step 255 of determining, by the task agent, based on the bidding messages and the one or more parameters of the task utility function, requested contributions of the RSAs to the execution of the task; wherein at least some of the suggested contributions are calculated by the RSAs in response to previously requested contributions of the RSAs to the execution of the task. The determining may apply a local optimization process. Local in the sense that it is not exhaustive and does not cover all possible allocations.
c. Step 257 of sending, by the computerized system and to the RSAs, the requested contributions of the RSAs to the execution of the task.

During the second till final bidding iteration (of the multiple bidding iterations) the bidding messages from the RSAs may be responsive to the requested contributions of the RSAs from a previous bidding iteration.

An RSA may participate in bidding iterations with a plurality of tasks agents allocated to a plurality of areas—and may select during any bidding iteration to cooperate with one of the plurality of task agents—and may even change its decision during the bidding iterations. Accordingly—the identity and/or number of RSAs that participate in one bidding iteration may differ from the identity and/or number of RSAs that participate in another bidding iteration.

The outcome of the multiple bidding iterations is an allocation of tasks to selected computerized systems that host agents. The selected computerized systems may host RSAs. One of the selected computerized systems may host the task agent.

Step 250 may be followed by checking whether the TA computerized system is allocated to convey one or more items of the GOI.

When the answer is positive—step 250 may be followed by step 260 of conveying, by the computerized system, at least one item from at least one source of the set of sources.

When the answer is negative—the computerized system does not convey any of the items of the GOI.

The task utility function may provide an indication about the monetary benefit gained to a conveying entity as a result of the conveying of the items of the GOI. Accordingly—the one or more parameters of the task utility function may include a profit gained from fulfilling the task and/or an item delivery urgency parameter. It should be noted that the task utility function may consider other benefits—for example reduction in emissions.

The GOI-related task skills may relate to the GOI—and may include, for example, item-type conveying capability and/or item-weight conveying capability, and/or item-volume conveying capability.

The item-type may be, for example, selected out of a fragile item, a non-fragile item, an item that requires certain environmental condition during a conveying of the item, or an item that may be conveyed regardless of environmental conditions. Different types of items may require different conveying conditions.

A bidding message from a given RSA may be compact. For example—it may consists essentially of (i) an expected time of arrival of the RSA to a task distribution location, (ii) one or more RSA item conveying skills, (iii) a status of the RSA and (iv) at least one interruption penalty for the RSAs to stop another task currently executed by the RSA. The status may be limited to parameters that are relevant to the conveying of an item—other than the RSA item conveying skills—for example—the status of the battery or the amount of fuel in the tank.

The at least one interruption penalty comprises multiple interruption penalties for stopping the other task at different stages of completion of the other task. The at least one interruption penalties may be determined by the task agent that assigned the RSA the other task.

When the method utilizes at least a part of the distributed solving of a Fisher market clearing process—then that part may include the executing of steps 230, 240 and 250.

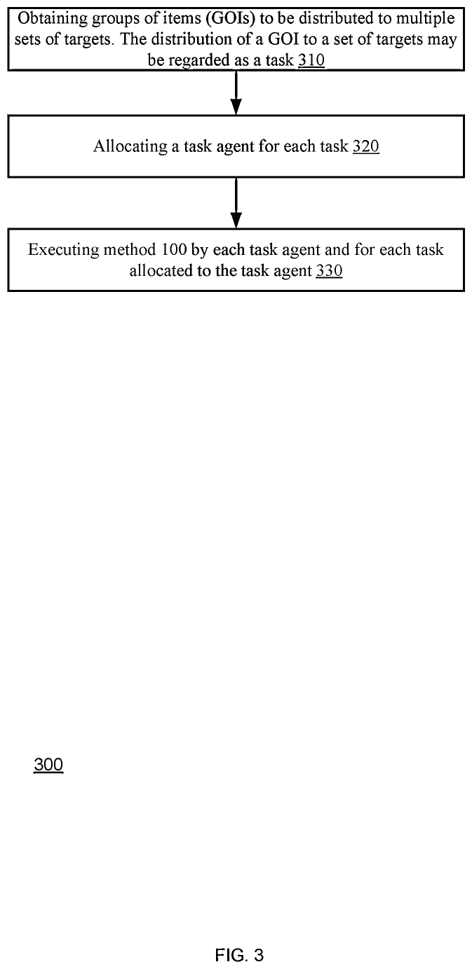

FIG. 3 illustrates an example of a computer based method 300 for executing tasks of conveying groups of items (GOIs) to sets of targets.

Method 300 may start by a initialization step 310.

Step 310 may include obtaining groups of items (GOIs) to be distributed to multiple sets of targets. The distribution of a GOI to a set of targets may be regarded as a task. The sets of items may or may not be defined when step 310 is executed.

Step 310 may include receiving the items to be distributed to the multiple sets of targets and clustering and/or grouping the items to provide the GOIs. The clustering and/or grouping may be responsive to the locations of the targets, access information regarding the access paths to the targets, types of items and the like. For example—different types of items that require different conveying conditions may be treated separately from each other.

Step 310 may be include receiving the (already clustered or grouped) GOIs to be distributed to multiple sets of targets.

Step 310 may be followed by step 320 of allocating a task agent for each task. There may be a single computerized system per task (per area). Alternatively, a single computerized system may be allocated to execute more than a single task. The tasks are associated one or more parameters of a task utility function.

Step 310 and/or step 320 may be executed in a centralized or distributed manner. It may be executed by the same computerized systems that will take part in the allocation of agents to each tasks, or may be executed by different computerized systems.

When executed in a distributed manner—one or more computerized systems may participate in the execution of step 310 and at least one computerized system may participate in the execution of step 320.

Step 320 may be followed by step 330 that includes executing method 100 by each task agent and for each task allocated to the task agent.

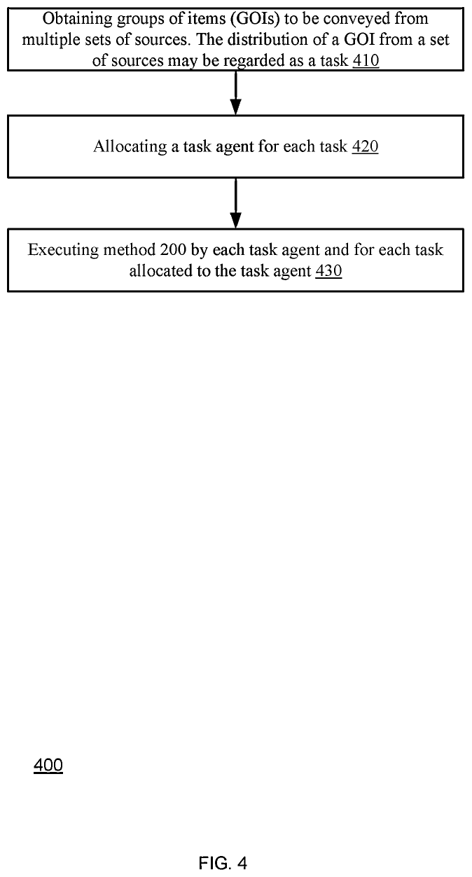

FIG. 4 illustrates an example of method 400 for executing a task of conveying a group of items (GOI) from a set of sources.

Method 400 may start by a initialization step 410.

Step 410 may include obtaining groups of items (GOIs) to be conveyed from multiple sets of sources. The conveying of a GOI from a set of sources may be regarded as a task.

Step 410 may include receiving the items to be conveyed from the multiple sets of sources and clustering and/or grouping the items to provide the GOIs. The clustering and/or grouping may be responsive to the locations of the sources, access information regarding the access paths to the sources, types of items and the like. For example—different types of items that require different conveying conditions may be treated separately from each other.

Step 410 may be include receiving the (already clustered or grouped) GOIs to be conveyed from multiple sets of sources.

Step 410 may be followed by step 420 of allocating task agents for each task. There may be a single computerized system per task (per area). Alternatively, a single computerized system may be allocated to execute more than a single task.

Step 410 and/or step 420 may be executed in a centralized or distributed manner. It may be executed by the same computerized systems that will take part in the allocation of agents to each tasks, or may be executed by different computerized systems.

When executed in a distributed manner-one or more computerized systems may participate in the execution of step 410 and at least one computerized system may participate in the execution of step 420.

Step 420 may be followed by step 430 that includes executing method 200 by each task agent and for each task allocated to the task agent.

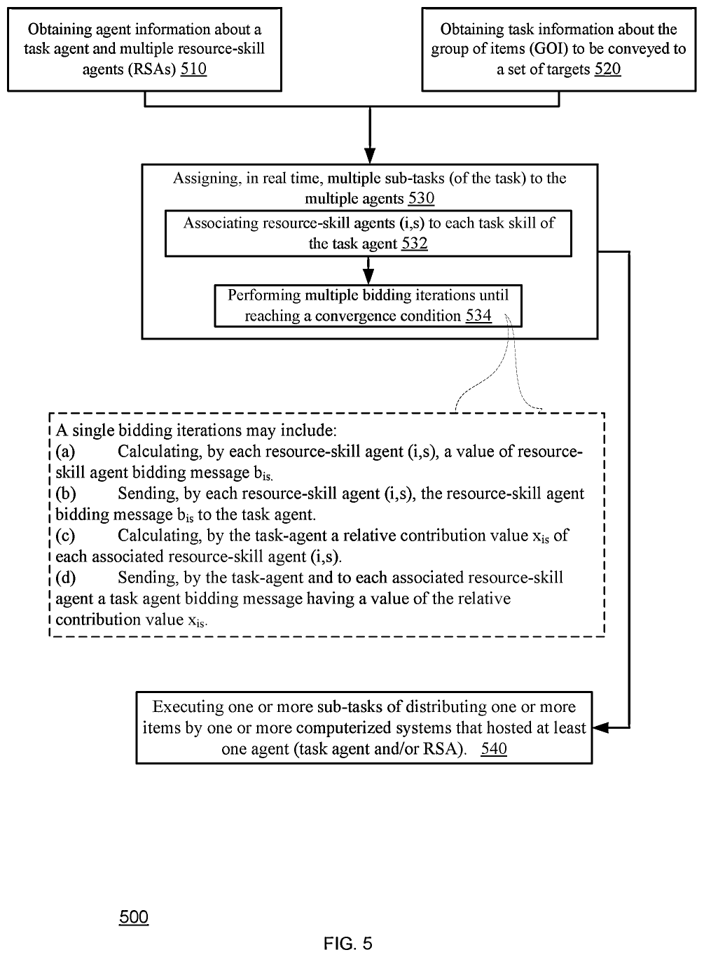

FIG. 5 illustrates an example of method 500 for dynamically allocating and scheduling a task for distributing a group of items (GOI).

Method 500 may start by steps 510 and 520.

Step 510 may include obtaining agent information about a task agent and multiple resource-skill agents (RSAs). Each agent has an agent skill set. An RSA has a RSA skill set related to the conveying of items. The task agent has a task agent skill set related to the conveying of items. The RSAs and the task agent may be hosted by a group of computerized systems, some of which are capable of conveying items.

Step 520 may include obtaining task information about the group of items (GOI) to be conveyed to a set of targets. The task is associated one or more parameters of a task utility function.

Steps 510 and 520 may be followed by step 530 of assigning, in real time, multiple sub-tasks (of the task) to the multiple agents. A sub-task may involve conveying an item to a target.

Step 530 may include performing, without testing all possible combinations of tasks assignments, a distributed solving of a Fisher market clearing process. The performing of the distributed solving may include steps 532 and 534.

Step 532 may include associating resource-skill agents (i,s) to each task skill of the task agent.

Step 534 may include performing multiple bidding iterations until reaching a convergence condition.

A single bidding iterations may include:
(a) Calculating, by each resource-skill agent (i,s), a value of resource-skill agent bidding message bᵢₛ.
(b) Sending, by each resource-skill agent (i,s), the resource-skill agent bidding message bᵢₛ to the task agent.
(c) Calculating, by the task-agent a relative contribution value xᵢₛ of each associated resource-skill agent (i,s).
(d) Sending, by the task-agent and to each associated resource-skill agent a task agent bidding message having a value of the relative contribution value xᵢₛ.

During one or more of the multiple bidding iterations a value of a bidding message is based on rᵢₛ, wherein rᵢₛ equals (a delayed start penalty of the resource agent for skill s)*(a utility contribution of the resource-skill agent using skill s for the task)−(an interruption penalty for the resource-skill agent i using skill s to work on another task).

Step 534 may also include allocating the sub-tasks based on values of xᵢₛ.

During a first bidding iteration and for each resource skill agent (i,s) the resource-skill agent bidding message equals rᵢₛ.

During a bidding iteration that follows the first bidding iteration and for each resource skill agent (i,s) the resource-skill agent bidding message equals xᵢₛ*rᵢₛ divided by the sum of xᵢₛ*rᵢₛ received by the resource-skill agent (i,s) from the task agent.

During each bidding iteration of the task, the task agent bidding message may equal a value of bᵢₛ divided by a sum of values of bᵢₛ received by the task agent from all associated resource-skill agents.

Step 534 may include ranking, by each resource-skill agent, tasks assigned to the resource-skill agent according to a benefit resulting to the resource-skill agent from performing the tasks.

The benefit may equal rᵢₛ multiplied by xᵢₛ.

The allocation of sub-tasks may include notifying by each resource-skill agent, other resource-skill agent assigned to the task with an earliest time the resource-skill agent may start the task.

The allocation of sub-tasks may include defining a task start time of the task as a latest time among the earliest times reported by the resource-skill agents assigned to the task.

The generating of the schedule may be responsive to the task start time of the task.

A utility contribution of the resource-skill agent using skill s for the task may be responsive to a difference between a current agent geographical location and the task geographical location

A resource-skill agent bidding message sent by a resource-skill agent may consists of a number of values, and be compact—for example smaller than 250 bytes.

Step 530 may be followed by step 540 of executing one or more sub-tasks of distributing one or more items by one or more computerized systems that hosted at least one agent (task agent and/or RSA).

It should be noted that while method 500 is related to the dynamically allocating and scheduling a task for distributing a GOI-a multi-task method may be provided and may include dynamically allocating and scheduling multiple tasks for distributing multiple GOIs to multiple sets of targets.

Method 500 may be applied, mutatis mutandis to the conveying of items from a set of sources.

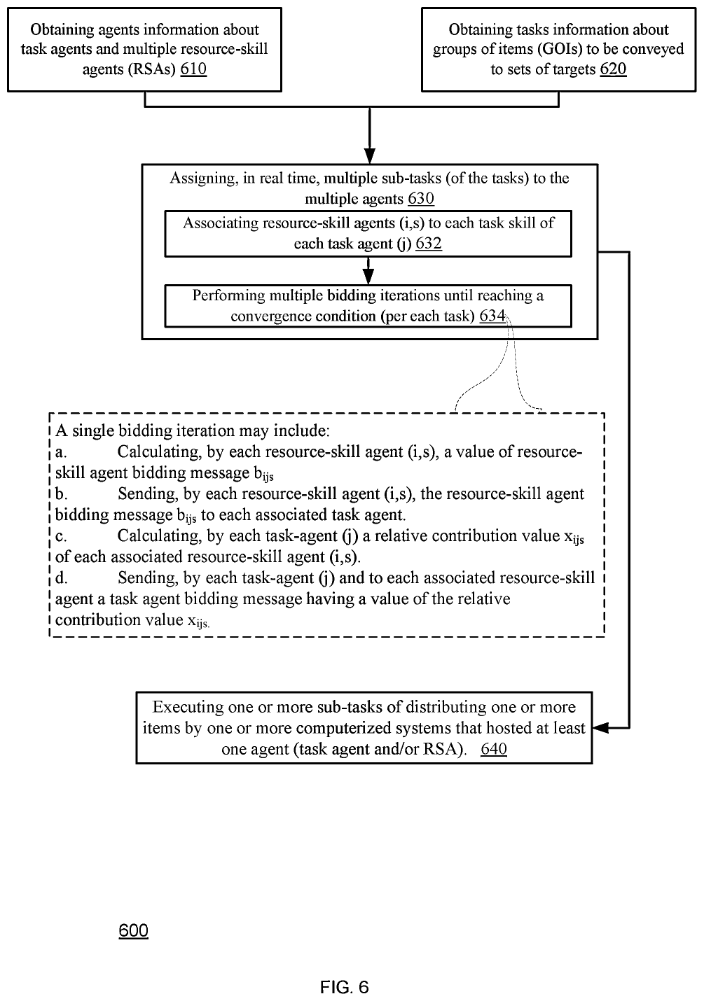

FIG. 6 illustrates an example of method 600 for dynamically allocating and scheduling tasks for distributing groups of items (GOIs) to sets of targets.

Method 600 may start by steps 610 and 620.

Step 610 may include obtaining agent information about task agents and multiple resource-skill agents (RSAs). Each agent has an agent skill set. An RSA has a RSA skill set related to the conveying of items. A task agent has a task agent skill set related to the conveying of items. The RSAs and the task agents may be hosted by groups of computerized systems, some of which are capable of conveying items.

Step 620 may include obtaining tasks information about the groups of items (GOIs) to be conveyed to the sets of targets. A task is associated one or more parameters of a task utility function.

Steps 620 and 630 may be followed by step 630 of assigning, in real time, multiple sub-tasks (of the tasks) to the multiple agents. A sub-task may involve conveying an item to a target.

Step 630 may include performing, without testing all possible combinations of tasks assignments, a distributed solving of a Fisher market clearing process. The performing of the distributed solving may include steps 632 and 634.

Step 632 may include associating resource-skill agents (i,s) to each task skill of each task agent (j).

Step 634 may include performing (per each task) multiple bidding iterations until reaching a convergence condition (per each task).

A single bidding iterations may include:
a. Calculating, by each resource-skill agent (i,s), a value of resource-skill agent bidding message bᵢⱼₛ.
b. Sending, by each resource-skill agent (i,s), the resource-skill agent bidding message bᵢⱼₛ to each associated task agent.
c. Calculating, by each task-agent (j) a relative contribution value xᵢⱼₛ of each associated resource-skill agent (i,s).
d. Sending, by each task-agent (j) and to each associated resource-skill agent a task agent bidding message having a value of the relative contribution value xᵢⱼₛ.

During one or more of the multiple bidding iterations a value of a bidding message is based on rᵢⱼₛ, wherein rᵢⱼₛ equals (a delayed start penalty of the resource agent for skill s)*(a utility contribution of the resource-skill agent using skill s for task j)−(an interruption penalty for the resource-skill agent i using skill s to work on task j).

Step 634 may also include allocating the sub-tasks based on values of xᵢⱼₛ.

During a first bidding iteration and for each resource skill agent (i,s) the resource-skill agent bidding message may equal rᵢⱼₛ.

During a bidding iteration that follows the first bidding iteration and for each resource skill agent (i,s) the resource-skill agent bidding message may equal xᵢⱼₛ*rᵢⱼₛ divided by the sum of xᵢⱼₛ*rᵢⱼₛ received by the resource-skill agent (i,s) from all associated task agents.

During each bidding iteration and for each task agent (j) the task agent bidding message may equal a value of bᵢⱼₛ divided by a sum of values of bᵢⱼₛ received by the task agent (j) from all associated resource-skill agents.

Step 634 may include ranking, by each resource-skill agent, tasks assigned to the resource-skill agent according to a benefit resulting to the resource-skill agent from performing the tasks.

The benefit may equal rᵢⱼₛ multiplied by xᵢⱼₛ.

The allocating the of the sub-tasks may include notifying by each resource-skill agent, other resource-skill agent assigned to a same task with an earliest time the resource-skill agent may start the task.

The allocating the of the sub-tasks may include defining a task start time of the task as a latest time among the earliest times reported by the resource-skill agents assigned to the same task.

The allocating the of the sub-tasks may be responsive to the task start time of each of the multiple tasks.

A utility contribution of the resource-skill agent using skill s for task j may be responsive to a difference between the agent geographical location and the task geographical location.

A resource-skill agent bidding message sent by a resource-skill agent may consists of a number of values, and be compact—for example smaller than 250 bytes.

A resource-skill agent bidding message sent by a resource-skill agent may consists of a number of values, wherein the number of values does not exceed a number of task agents associated with the resource-skill agent.

A task agent bidding message sent by a task agent may consist of a number of values, wherein the number of values does not exceed a number of resource-skill agents associated with the task agent.

Step 630 may be followed by step 640 of executing one or more sub-tasks of distributing one or more items by one or more computerized systems that hosted at least one agent of any of the task agents and/or any of the RSAs.

Method 600 may be applied, mutatis mutandis to the conveying of items from sets of sources.

An example of a method for solving a problem related to the conveying of items using the Fisher market clearing task is illustrated below.

The method may include:
a. Modelling the problem as a multi-vehicle delivery optimization problem. The model may include the following parameters: (i) the packages that need to be transferred, their pickup locations, the delivery locations, the utility derived from transferring them (taking into consideration the importance of the item, the urgency of its delivery and the cost for late delivery), the capabilities required from vehicles that transfer them, such as the capability to handle a certain weight, (ii) the transferring vehicles (“last mile vehicles”), their current locations with respect to the pick-up locations, capabilities, the cost for having them not complete their current assignments, and their current locations.
b. Reducing of the model to a representation to input to a Fisher market clearance algorithm, with vehicles representing “agents” in the traditional algorithm. The input to the algorithm is a matrix of rᵢⱼₛ terms, each term defining the utility that vehicle i will derive from applying capability s on delivery j.
c. Performing a bidding process based on the Fisher market clearance algorithm, to find the market clearing equilibrium of vehicle assignment utility values and the corresponding allocation of delivery assignments, which may include coalitions formed for each of the deliveries.
d. Scheduling the actions of vehicles and coordinating coalition actions. The scheduling include allocating the vehicles to sub-tasks.

A more detailed example of a method is provided below.

The method may be executed by one or more include computerized systems. The method may include:
a. Receiving a set of delivery orders, including pick-up and delivery locations, types of packages in each order, package weights and other capability requirements, and delivery priorities (delivery order utility functions).
b. Determining a current location for each delivery vehicle in a fleet, where each delivery vehicle is also associated with a set of capabilities, such as load capabilities and speeds.
c. Performing an iterative bidding simulation of calculating vehicle assignment utility values from the parameters of the package utility functions, as well as delayed pick-up and delivery penalties, a delivery interruption penalty, and a vehicle contribution function.
d. Generating a schedule of the assigned plurality of deliveries for each vehicle by ranking the assigned plurality of deliveries according to the vehicle assignment utility ranking.
e. Changing a schedule of assigned deliveries to coordinate pick-up and delivery times.
f. Conveying (when assigned to) one or more items by at least one of the one or more computerized systems.

The vehicle assignment utility ranking, for a given delivery assigned to a given vehicle, may equal a delivery order utility value, for the given delivery assigned to the given vehicle, divided by the given vehicle's portion of the delivery order.

The delayed start penalty may be a function of a difference between a start time of a given delivery and a time that a notification of the delivery was received by the computing system. The delivery interruption penalty of a vehicle assignment utility is a function of a predefined interruption penalty factor of a current delivery and an amount of work performed by the given vehicle. The contribution function may be the maximum contribution a given vehicle provides to the utility of a given delivery, assuming an optimal assignment of vehicles to the given delivery.

The changing an order of assigned deliveries of the schedule of at least one vehicle may include applying a distributed process, the distributed process may include sending from each of the multiple vehicles to each of the other multiple vehicles a notification of an earliest time of arrival to the shared delivery.

Each of the multiple vehicles may determine the start time for the shared delivery as the latest time of all the earliest times.

When there is a need to encourage collaboration by vehicles performing specific deliveries, the vehicle assignment utility values may be determined by concave, exponential functions, wherein the exponents of the functions are greater than 0 and less than 1, such that the simulated auction assigns more shared deliveries to the vehicles than when the vehicle assignment utility values are determined by linear functions. The exponent is set according to a need for cooperation on a delivery.

Assuming computerized systems that are located within vehicles such as trucks, scooters and drones. When there are multiple tasks, a coalition of vehicles that attend to each task may include at least one truck that brings the relevant packages to an area distribution location—that may be centered position in the area of delivery. Scooters or drones or both, which take packages from the trucks and deliver them to the delivery address.

It should be noted that a vehicle (drone or scooter) can be a member in a number of coalitions, thus, after delivering a package from one truck in a certain area, it can deliver a package from another truck in a nearby area. Moreover, when the truck is emptied, and it returns to the warehouse to reload packages, drones and scooters can cooperate with other trucks and keep deliver. Battery charging and fulling can be done in specific points near the areas of delivery.

Notice, scooters, and drones are realistic examples for delivering vehicles, with different capabilities. The model and the method are not restricted to these type of delivery vehicles.

More formally, the Package Delivery Problem (PDP) is composed of:
M distribution areas—A₁, A₂, Aᵢ . . . , A_{M}, with a center location L(Aᵢ).
Every area i has demand for kᵢ packages—p_{i,1}, p_{i,2}, . . . , p_{i,j}, . . . , p_{i,k}_{ᵢ}

Every package p_{i,j} has:
Weight W(p_{i,j}) and Volume V(p_{i,j})
Type (classification) C(p_{i,j})∈[c₁, cₗ, . . . , c_{C}]
Revenue from the package—R(p_{i,j})
Importance (urgency)—I(p_{i,j})
Location L(pⱼⁱ)
Due date DD(p_{i,j})
Actual delivered time AD(p_{i,j})
Penalty for lateness—Penₚ_{_{i,j}}(I(p_{i,j}), R(p_{i,j}))

Every area i and every type tₗ has a required workload:
Total weight of packages from type tₗ Wᵢ^{c}^{ₗ}=ΣⱼW(p_{i,j}), for C(p_{i,j})=cₗ
Total volume of packages from type tₗ Vᵢ^{c}^{ₗ}=ΣⱼV(p_{i,j}), for C(p_{i,j})=cₗ
Total amount of packages from type tₗ Countᵢ^{c}^{ₗ}=ΣⱼI(p_{i,j}), I(p_{i,j})=1 if C(p_{i,j})=cₗ

The packages can be delivered by:
k_{T} Trucks: T₁, T₂, . . . , Tₖ_{^{T}} with a limited volume V(T)
k_{S} Scooters—S₁, S₂, . . . , Sₖs with a limited volume V(S). Every scooter has a set of package types that it can deliver C(S)⊆[c₁, cₗ, . . . , c_{T}]
K_{D} Drones—D₁, D₂, . . . , Dₖ_{^{D}} with a limited weight W(D). Every drone has a set of package types that it can deliver C(D)⊆[c₁, cₗ, . . . , c_{T}], and it is a subset of package types that the scooter can deliver C(S)⊆C(D).

For each area, the utility derived is calculated as the sum of the utilities derived for each of the packages delivered:

$${U}_{{p}_{i , j}} = I ( {p}_{i , j} ) R ( {p}_{i , j} ) - ( AD ( {p}_{i , j} ) - DD ( {p}_{i , j} ) ) * {Pen}_{{p}_{i , j}} \\ {U}_{i} ( σ ) = {\sum }_{j = 1}^{{k}_{i}} {U}_{{p}_{i , j}} ( σ )$$

The utility for a solution σ is the sum of areas utilities.

$$U ( σ ) = {\sum }_{i = 1}^{M} {U}_{i} ( σ )$$

Variables rᵢⱼₛ may be entries of a R matrix, which are reductions of the utility (described above) that an vehicles derive from delivering packages. They are calculated by taking into consideration the urgency of the package delivery, the utility derived from receiving it, the time it will take the vehicle to deliver it and the loss for not performing other deliveries. The term rᵢⱼₛ is specific for a capability, that is when vehicles having multiple capabilities, such as vehicles that can pack a package and deliver, or vehicles with different capacities for different weight loads.

Yet for another example—any of the mentioned above methods may be apply to conveying items within a warehouse. For example—movable robots of different types may be used to convey items from different locations of a warehouse. One or more movable robots may be one or more task agents or one or more areas within the warehouse.

In order to improve the pick and pack process within the warehouse, the items to be conveyed may be clustered per area. This clustering process can allow a vehicle to collect a number of items that are located nearby in the warehouse, even though they may be required for different orders or even need to be loaded to a different truck (to be conveyed outside the warehouse).

The clustering method allows us to cut the number of collection tasks, avoid traffic jams of vehicles near locations in the warehouse where popular items are stored and to speed the colleting process.

The clustering may be beneficial, for example, when a picker can pick a number of items and carry them to the packing area. In this case the aim of the clustering method is to identify items that can be picked together as a single task.

The clustering may be beneficial, for example, when pickers are limited to a small number of items. In this case the aim of the clustering method is to identify similar tasks that can be performed by a number of pickers. Pickers are sent to the area of a cluster of picking tasks and they get their specific task assigned to them when they arrive.

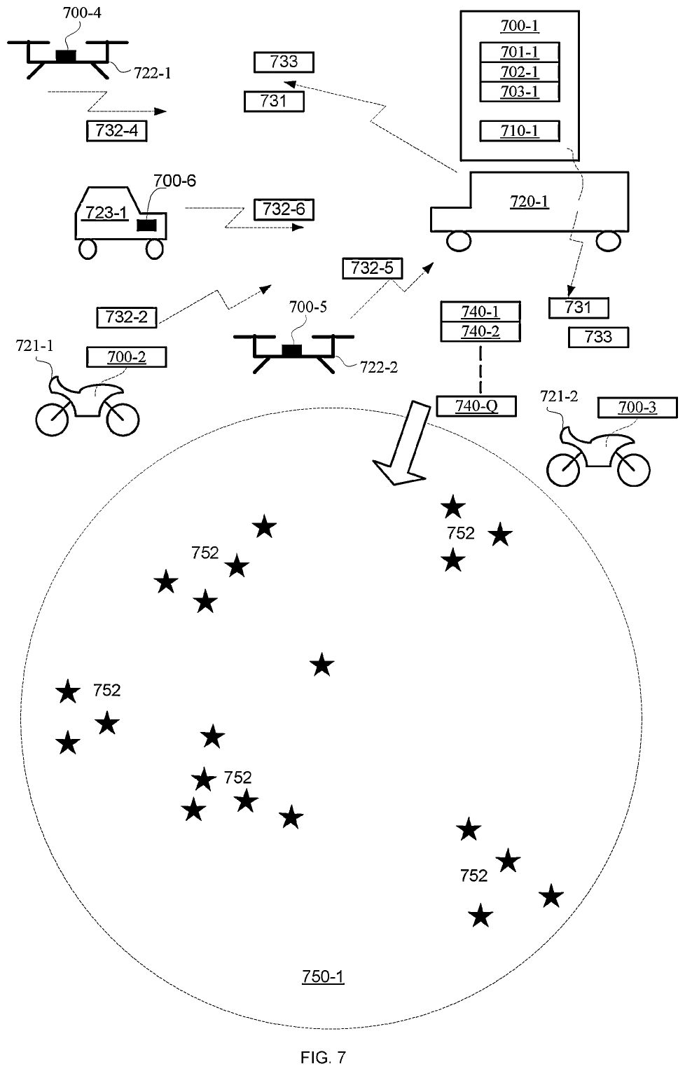

FIG. 7 illustrates an example of computerized systems, items of a GOP and a set of targets. FIG. 7 illustrates area 750-1 in which multiple targets 752 are located, Q items 740-1 till 740-Q to be conveyed to the targets, a task agent 710-1 hosted by first computerized system 700-1 that belongs to truck 720-1, RSAs that are hosted by various computerized systems of various vehicles-including second computerized system 700-2 of first motorcycle 721-1, third computerized system 700-3 of second motorcycle 721-2, fourth computerized system 700-4 of first drone 722-1, fifth computerized system 700-5 of second drone 722-2, and six computerized system 700-6 of first car 723-1. The first computerized system 700-1 may include computational resources such as processor 701-1 (includes one or more processing circuits), memory resources such as memory unit 702-1, communication unit 701-3 for communicating with other computerized systems. Any other computerized system may include computational resources, memory resources and communication resources.

FIG. 7 also illustrates informing messages 731 and 733 sent from the task agent to the RSAs and bidding messages from the individual computerized systems such as 732-2, 732-4, 732-5 and 732-6.

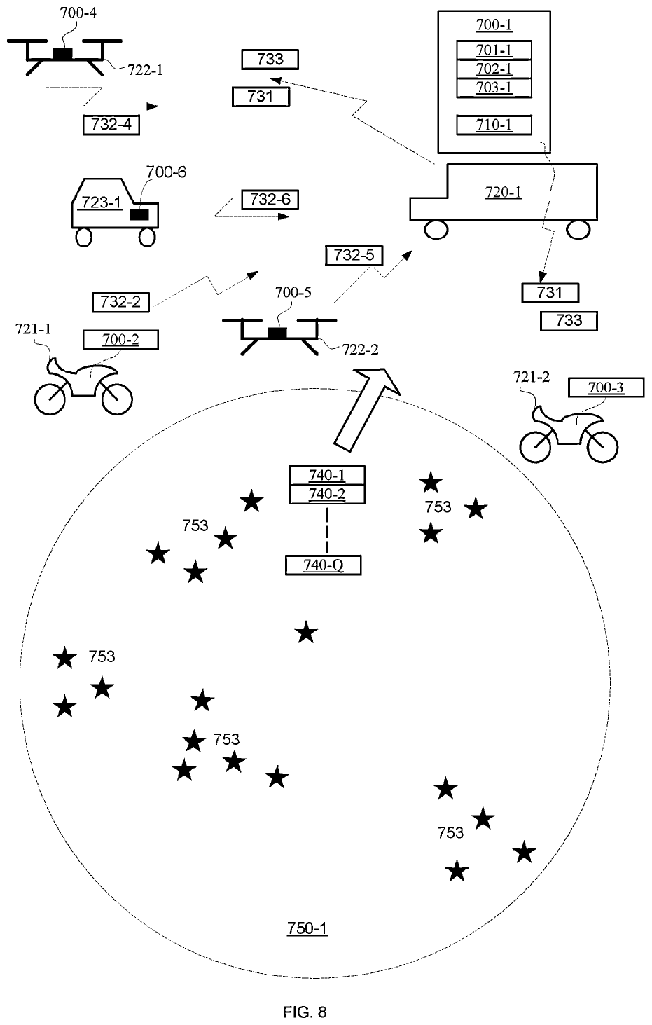

FIG. 8 illustrates an example of computerized systems, items of a GOP and a set of sources. FIG. 8 differs from FIG. 7 by illustrating a set of sources 753 instead of a set of targets and having the items (740-1 till 740-Q) within the area—and they should be collected from the area.

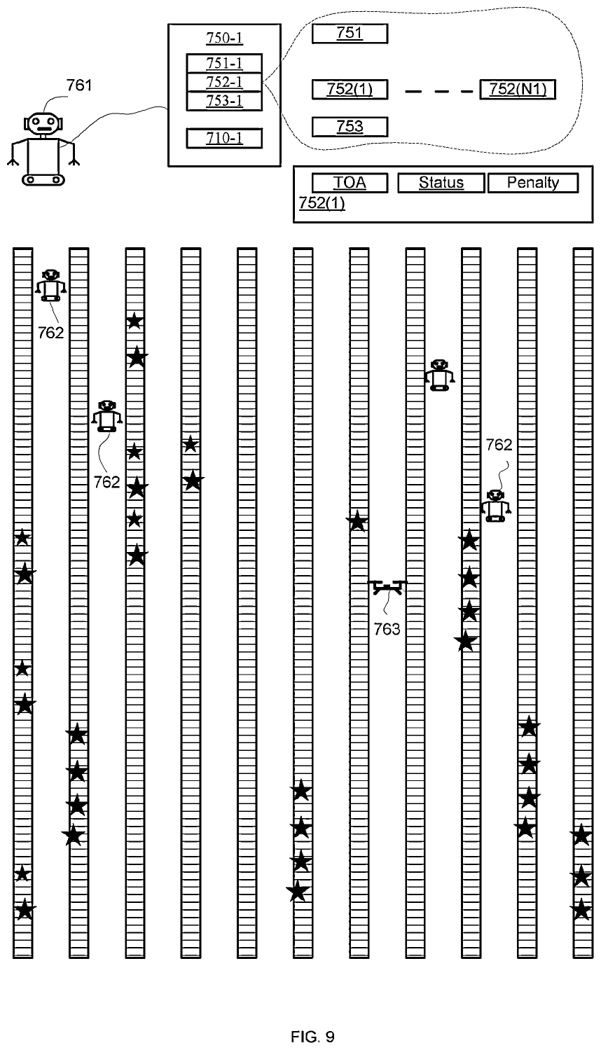

FIG. 9 illustrates multiple robots that execute a task of obtaining items of a GOI from an area within the warehouse. The items are represented by stars. The warehouse include shelves that store the items. In FIG. 9 robot 761 hosts the task agent. Other robots 762 and other drones 763 host the RSAs.

FIG. 9 illustrates the robot 791 as including computerized system 750-1. The computerized system 750-1 that may include computational resources such as processor 751-1 (includes one or more processing circuits), memory resources such as memory unit 752-1, communication unit 751-3 for communicating with other computerized systems. Any other computerized system may include computational resources, memory resources and communication resources. Memory unit 752-1 is illustrates as storing task agent messages such as task agent message informing the RSAs about GOI-related task skills 751, bidding messages from N1 RSAs 752(1)-752 (N1), and a task agent message 753 indicative of the requested contributions. A bidding message 752(1) consists essentially of a time of arrival, status and penalty for interrupting a task. The messages are compact and the memory unit may store messages related to many bidding iterations-without consuming a significant memory space. The computation burden, especially of a RSA may be so insignificant that it may be executed as a background process or by a controller or a weak processor.

Any of the robots, and any of the RSAs and any of the vehicles are movable using an engine or any other movement unit.

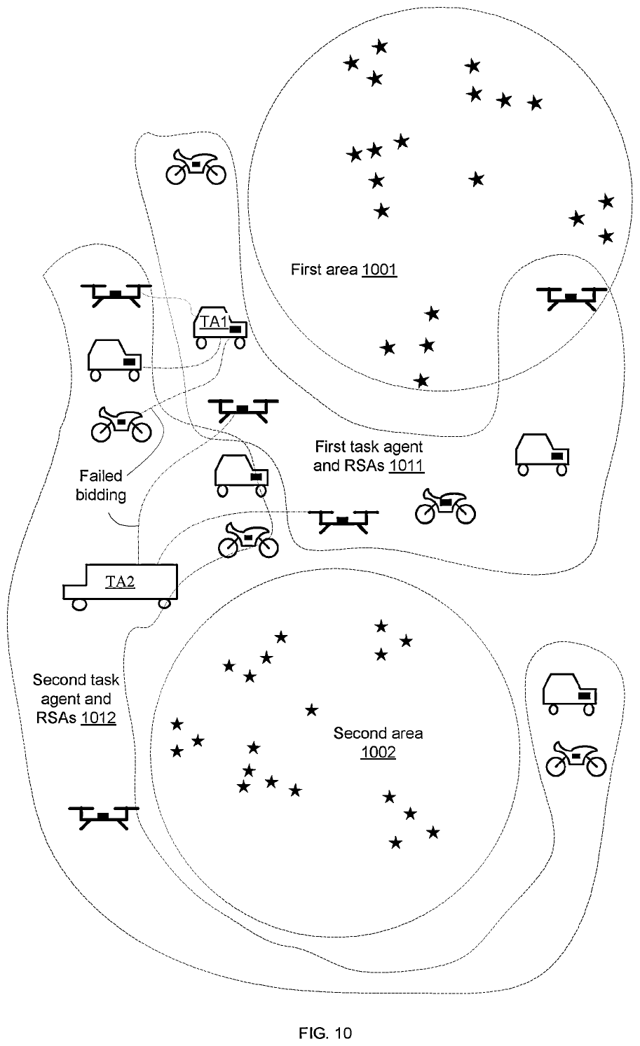

FIG. 10 illustrates an example of tasks agents TA1 and TA2, first and second areas 1001 and 1002 and associated areas. The first area 1001 is served by first task agent TA1 and first RSAs collectively denoted 1011. The second area 1002 is served by second task agent TA2 and second RSAs collectively denoted 1012. RSAs may participate in bidding iterations—with more than one task agent. FIG. 1 illustrates a few RSAs the participated in bidding iterations and selected one of the task agents. A bidding of a task agent with an RSA that selected to cooperate with the other task agent is denoted “failed bidding”.

It should be noted that any combination and task agents and/or RSAs may be provided. That any combination of any steps of any method illustrated in the specification and/or drawings can be combined—For example method 200 may be executed to collect a GOI from sources, once the collection is completed, method 100 may be executed for delivering the GOI to a set of targets. Yet for another example method 100 may precede method 200.

This application provides a significant technical improvement over the prior art—especially an improvement in computer science.

Any reference to the term “comprising” or “having” should be interpreted also as referring to “consisting” of “essentially consisting of”. For example—a method that comprises certain steps can include additional steps, can be limited to the certain steps or may include additional steps that do not materially affect the basic and novel characteristics of the method-respectively.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a computer program product such as non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc. A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system. The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A computer based method for executing a task of conveying a group of items (GOI) to a set of targets, the method comprises:
receiving, by a computerized system, (i) a request to execute the task, (ii) GOI-related task skills required for conveying the group of items, and (iii) one or more parameters of a task utility function;
associating, by a task agent hosted by the computerized system, resource-skill agents (RSAs) to each GOI-related task skill; wherein the RSAs are heterogenous;
informing the RSAs about the GOI-related task skills;
participating, by the task agent, in multiple bidding iterations until reaching a convergence condition; wherein the bidding iterations explore only a fraction of all possible task allocations; and
conveying, by the computerized system, at least one item towards at least one target of the set of target when the computerized system is allocated, during the multiple bidding iterations, to convey the at least one item towards the at least one target;
wherein a participating in a bidding iteration of the multiple bidding iteration comprises:
(a) receiving bidding messages from the RSAs, wherein the bidding messages provide information about (i) suggested contributions of the RSAs to an execution of the task, and (ii) interruption penalties for the RSAs to stop other tasks currently executed by the RSAs;
(b) determining, by the task agent, based on the bidding messages and the one or more parameters of the task utility function, requested contributions of the RSAs to the execution of the task; wherein at least some of the suggested contributions are calculated by the RSAs in response to previously requested contributions of the RSAs to the execution of the task; and
(c) sending, by the computerized system and to the RSAs, the requested contributions of the RSAs to the execution of the task.

2. The method according to claim 1, wherein the one or more parameters of the task utility function comprises at least one of (i) a profit gained from fulfilling the task or (ii) an item delivery urgency parameter.

3. The method according to claim 2, wherein the GOI-related task skills comprise at least two out of item-type conveying capability, item-weight conveying capability and item-volume conveying capability.

4. The method according to claim 3, wherein the item-type is selected out of a fragile item, a non-fragile item, an item that requires certain environmental condition during a conveying of the item, or an item that may be conveyed regardless of environmental conditions.

5. The method according to claim 1, wherein the determining comprises applying a local optimization process.

6. The method according to claim 1, wherein a bidding message from a given RSA consists essentially of (i) an expected time of arrival of the RSA to a task distribution location, (ii) one or more RSA item conveying skills, (iii) a status of the RSA and (iv) at least one interruption penalty for the RSAs to stop another task currently executed by the RSA.

7. The method according to claim 6 wherein the at least one interruption penalty comprises multiple interruption penalties for stopping the other task at different stages of completion of the other task.

8. The method according to claim 1, wherein a size of a bidding message does not exceed 250 bytes.

9. The method according to claim 1, wherein the associating, informing and the participating form a part of a distributed solving of a Fisher market clearing process.

10. The method according to claim 1, wherein the computerized system belongs to a vehicle of a first type and wherein at least some of the RSAs are vehicles of one or more types that differ from the first type.

11. The method according to claim 10, wherein the GOI are located within an area, wherein the computerized system is configured to convey the GOI to an area distribution location, and wherein the at least some of the RSAs are configured to distribute different items of the GOIs from the area distribution location to the set of targets.

12. The method according to claim 10, wherein the GOI are located within an area, wherein another RSA is configured to convey the GOI to an area distribution location, and wherein the computerized system is configured to distribute some of the items of the GOIs from the area distribution location to some of set of targets.

13. The method according to claim 1 wherein the receiving, associating, informing, and participating are executed in real time.

14. The method according to claim 1 wherein a usage of memory resources and computational resources of the computerized system during the participating is polynomial or pseudo-polynomial in a number of RSAs.

15. The method according to claim 1 wherein the GOI comprises different items associated with different item-related parameters, and wherein the GOI-related task skills reflect the different item-related parameters.

16. A vehicle, comprising:
a computerized system that is configured to:
receive (i) a request to execute the a task of conveying a group of items (GOI) to a set of targets, (ii) GOI-related task skills required for conveying the group of items, and (iii) one or more parameters of a task utility function;
associate, by a task agent hosted by the computerized system, resource-skill agents (RSAs) to each GOI-related task skill; wherein the RSAs are heterogenous;
inform the RSAs about the GOI-related task skills;
participate, by the task agent, in multiple bidding iterations until reaching a convergence condition; wherein the bidding iterations explore only a fraction of all possible task allocations; and
convey at least one item towards at least one target of the set of target when the computerized system is allocated, during the multiple bidding iterations, to convey the at least one item towards the at least one target;
wherein a participating in a bidding iteration of the multiple bidding iteration comprises:
(d) receiving bidding messages from the RSAs, wherein the bidding messages provide information about (i) suggested contributions of the RSAs to an execution of the task, and (ii) interruption penalties for the RSAs to stop other tasks currently executed by the RSAs;
(e) determining, by the task agent, based on the bidding messages and the one or more parameters of the task utility function, requested contributions of the RSAs to the execution of the task; wherein at least some of the suggested contributions are calculated by the RSAs in response to previously requested contributions of the RSAs to the execution of the task; and
(f) sending, by the computerized system and to the RSAs, the requested contributions of the RSAs to the execution of the task.

17. A non-transitory computer readable medium for executing a task of conveying a group of items (GOI) to a set of targets, the non-transitory computer readable medium stores instructions that once executed by a computerized system cause the computerized system to:
receive (i) a request to execute the task, (ii) GOI-related task skills required for conveying the group of items, and (iii) one or more parameters of a task utility function;
associate, by a task agent hosted by the computerized system, resource-skill agents (RSAs) to each GOI-related task skill; wherein the RSAs are heterogenous;
inform the RSAs about the GOI-related task skills;
participate, by the task agent, in multiple bidding iterations until reaching a convergence condition; wherein the bidding iterations explore only a fraction of all possible task allocations; and
convey at least one item towards at least one target of the set of target when the computerized system is allocated, during the multiple bidding iterations, to convey the at least one item towards the at least one target;
wherein a participating in a bidding iteration of the multiple bidding iteration comprises:
(a) receiving bidding messages from the RSAs, wherein the bidding messages provide information about (i) suggested contributions of the RSAs to an execution of the task, and (ii) interruption penalties for the RSAs to stop other tasks currently executed by the RSAs;
(b) determining, by the task agent, based on the bidding messages and the one or more parameters of the task utility function, requested contributions of the RSAs to the execution of the task; wherein at least some of the suggested contributions are calculated by the RSAs in response to previously requested contributions of the RSAs to the execution of the task; and
(c) sending, by the computerized system and to the RSAs, the requested contributions of the RSAs to the execution of the task

18. A computer based method for executing a task of conveying a group of items (GOI) from a set of sources, the method comprises:
receiving, by a computerized system, (i) a request to execute the task, (ii) GOI-related task skills required for conveying the group of items, and (iii) one or more parameters of a task utility function;
associating, by a task agent hosted by the computerized system, resource-skill agents (RSAs) to each GOI-related task skill; wherein the RSAs are heterogenous;
informing the RSAs about the GOI-related task skills;
participating, by the task agent, in multiple bidding iterations until reaching a convergence condition; wherein the bidding iterations explore only a fraction of all possible task allocations; and
conveying, by the computerized system, at least one item from at least one source of the set of sources when the computerized system is allocated, during the multiple bidding iterations, to convey the at least one item from the at least one source;
wherein a participating in a bidding iteration of the multiple bidding iteration comprises:
(a) receiving bidding messages from the RSAs, wherein the bidding messages provide information about (i) suggested contributions of the RSAs to an execution of the task, and (ii) interruption penalties for the RSAs to stop other tasks currently executed by the RSAs;
(b) determining, by the task agent, based on the bidding messages and the one or more parameters of the task utility function, requested contributions of the RSAs to the execution of the task; wherein at least some of the suggested contributions are calculated by the RSAs in response to previously requested contributions of the RSAs to the execution of the task; and
(c) sending, by the computerized system and to the RSAs, the requested contributions of the RSAs to the execution of the task.
